(19) United States
(12) Patent Application Publication
(10) Pub. No.: US 2005/0260501 A1
(43) Pub. Date: Nov. 24, 2005

(54) Electrolyte and lithium secondary battery

(76) Inventors: Takefumi Okumura, Hitachi (JP); Shin Nishimura, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/055,485

(22) Filed: Feb. 11, 2005

(30) Foreign Application Priority Data
May 20, 2004 (JP) 2004-150203

(51) Int. Cl. H01M 10/40

(52) U.S. Cl. 429/317

(57) ABSTRACT

An electrolyte with excellent ionic conductivity, and a lithium secondary battery utilizing the electrolyte for increased level of safety. The lithium secondary battery comprises a positive and a negative electrode that reversibly intercalate and deintercalate lithium, and an electrolyte containing a lithium ion. The electrolyte comprises: a polymer having a carbonate group represented by formula 1 below: 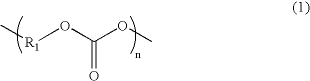
where R₁ is a hydrocarbon group with a carbon number of 2 to 7, and n is an integer from 10 to 10000; an electrolyte salt; and an organic solvent. The electrolyte salt is contained with a molar ratio of 0.2 or more with respect to the carbonate group, thereby providing the battery with an excellent ionic conductivity and high levels of safety.

### BACKGROUND OF THE INVENTION

1. Field of the Invention

The present invention relates to an electrolyte and a lithium secondary battery utilizing the electrolyte.

2. Description of Related Art

Generally, as electrolytes used in electrochemical devices, such as batteries, capacitors, and sensors, liquid electrolytes are known that consist of a high-permittivity organic solvent to which an electrolyte salt has been added. Although these liquid electrolytes provide a high ionic conductivity, they require a container that is completely hermetically sealed by providing the exterior member with a certain thickness so as to prevent fluid leakage from the container, for example.

In addition, solid electrolytes have also been proposed, such as inorganic crystalline substances, inorganic glass, and organic polymers. In these solid electrolytes, there is less fluid leakage and less likelihood of ignition than in the case of liquid electrolytes, such as those employing a carbonate solvent, resulting in enhanced device reliability and safety. In particular, since organic polymers have an excellent processibility and moldability, electrolytes obtained therefrom have flexibility and bending workability, such that the degree of freedom in designing devices can be increased. However, solid electrolytes made of organic polymers have been problematic in that their ionic conductivity is generally low at temperatures close to room temperature, compared with the case of liquid electrolytes.

To address this problem, electrolytes have been disclosed where the decrease in ionic conductivity near room temperature is prevented, such as a solid polymer electrolyte that employs a polymer containing carbonate-group (see Patent Document 1). There has also been disclosed a solid polymer electrolyte to which an organic solvent has been added (see Patent Document 2).
Patent Document 1: JP Patent Publication (Kokai) No. 8-217869 A (1996)
Patent Document 2: JP Patent Publication (Kokai) No. 8-217868 A (1996)

### SUMMARY OF THE INVENTION

In the solid polymer electrolyte disclosed in Patent Document 1, however, when LiClO₄ is used as an electrolyte salt, for example, although the ionic conductivity increases as the molar ratio (meltage) of the electrolyte salt relative to the carbonate group increases, the ionic conductivity decreases as the molar ratio exceeds 0.5. Therefore, the maximum ionic conductivity value is now on the order of 0.2 (mS/cm), which is still lower than the watershed level for practical utilization, or approximately 1 (mS/cm).

In Patent Document 2, a solid polymer electrolyte with an ion conductivity exceeding the important level of approximately 1 (mS/cm) for practical application is obtained by adding an organic solvent as a plasticizer. However, the content of the organic solvent is 50 to 90 parts by weight relative to 100 parts by weight of the organic polymer. Thus, further reduction of the organic solvent content is required from the viewpoint of reliability and safety.

It is therefore an object of the invention to provide a lithium secondary battery that has superior reliability and safety in terms of ionic conductivity and as a device.

Initially, the principle of the present invention will be described. It is well accepted that a donor group of a polymer in a solid polymer electrolyte interacts with a cation of an electrolyte salt. By introducing a carbonate group that has an appropriate level of correlation with a cation as a constituent unit of a polymer, a cation can easily hop from a carbonate group to the other group, thereby improving the ionic conductivity. The inventors realized that, by adding high levels of an electrolyte salt with a plasticizing effect to a polymer including a carbonate group as shown in formula 1: 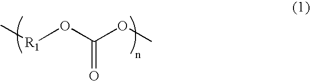
where R₁ is a hydrocarbon group with a carbon number of 2 to 7, and n is an integer from 10 to 10000, ionic conductivity can be improved while decreasing the content of the organic solvent as a plasticizer.

In this case, the concentration of the electrolyte salt in the solid polymer electrolyte is set to be 0.2 or larger, and preferably 0.7 or larger, in terms of molar ratio with respect to the carbonate group. The upper-limit value of the added amount corresponds to the dissolution limit of the electrolyte salt with respect to the polymer. When the added amount of the electrolyte salt is increased in this range, ionic conductivity improves. As such electrolyte salt, at least one is preferably selected from the group consisting of LiN(CF₃SO₂)₂, LiN(C₂F₅SO₂)₂, and LiC(CF₃SO₂)₃.

In accordance with the invention, a lithium secondary battery comprising a positive electrode and a negative electrode that reversibly intercalate and deintercalate a lithium ion, and an electrolyte containing a lithium ion, is provided. The lithium secondary battery has an excellent ionic conductivity and a device safety thanks to the utilization of the aforementioned solid polymer electrolyte.

As mentioned above, the invention makes it possible to obtain a lithium secondary battery with an excellent ion conductivity and device safety, and a polymer electrolyte utilizing the same.

### BRIEF DESCRIPTION OF THE DRAWINGS

FIG. 1 shows a perspective view of a lithium secondary battery according to the invention, in which the aluminum laminate film of the battery container is open.

### DETAILED DESCRIPTION OF THE PREFERRED EMBODIMENTS

The invention will be hereafter described by way of a preferred embodiment thereof. In the present embodiment, the electrolyte is predominantly composed of a polymer containing a carbonate group, and an electrolyte salt. The carbonate group herein refers to the structure —O—(C═O)—O—. The polymer herein refers to a compound with a structure represented by formula 1. R₁ in formula 1 indicates a hydrocarbon group with a carbon number of 2 to 7. Examples are aliphatic hydrocarbon groups including ethylene, propylene, butylene, pentylene, dimethyltrimethylene, dimethyltetramethylene, and dimethylpentamethylene. If the carbon number increases, the ratio of the carbonate group in a predetermined weight decreases, whereby the region in which the lithium ion, for example, can be arranged decreases, thereby decreasing ionic conductivity. However, if the carbon number decreases, the polymer tends to be more likely to be crystallized, which interferes with the movement of ions. Thus, the carbon number is preferably 2 or 3. The sign n in formula 1 indicates the number of moles added, which is 10 to 1000, or preferably 100 to 1000. 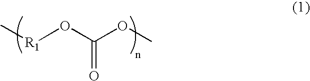
(R₁ is a hydrocarbon group with a carbon number of 2 to 7, and n is an integer from 10 to 10000.)

The electrolyte salt in the present embodiment may be any electrolyte salt that is adapted for lithium secondary batteries, for example, and that has a plasticizing effect. Specifically, LiN(CF₃SO₂)₂, LiN(C₂F₅SO₂)₂, and LiC(CF₃SO₂)₃, for example, are preferable. The concentration of the electrolyte salt in the electrolyte is 0.2 or more in terms of molar ratio with respect to the carbonate group, and is preferably 0.7 or more. In this case, the upper-limit value corresponds to the dissolution limit of the electrolyte salt with respect to the polymer.

The organic solvent in the present embodiment may be any organic solvent adapted for lithium secondary batteries, for example. Examples include ethylene carbonate, propylene carbonate, gamma butyrolactone, dimethyl carbonate, butylene carbonate, diethyl carbonate, ethyl methyl carbonate, diethylene glycol dimethyl ether (diglyme), tetrahydrofuran, and diethylether. From the viewpoint of safety of the secondary battery, the higher the boiling point of the organic solvent, the better. At the same time, as a plasticizer, diethylene glycol dimethyl ether (diglyme), gamma butyrolactone, and propylene carbonate are particularly preferable. The content of the organic solvent is 1 to 50 parts by weight with respect to 100 parts by weight of the carbonate group-containing polymer. From the viewpoint of safety of the secondary battery, the content of the organic solvent is preferably low, preferably from 5 to 45 parts by weight and more preferably from 10 to 30 parts by weight. Thus, it is particularly preferable to select an amount of the organic solvent such that the aforementioned polymer is not completely dissolved but can become sufficiently swollen. The amount of the organic solvent that satisfies these conditions is dependent on the molecular weight of the polymer, namely the value of n. In Patent Document 2, a polymer with a relatively small molecular weight—namely, with n of 6 or smaller—is used as a concrete example, and the content of the organic solvent is 50 to 900 parts by weight with respect to 100 parts by weight of the polymer. Thus, the relationship between the polymer and the organic solvent content in the present invention is actually vastly different from that of Patent Document 1.

In the present embodiment, the lithium secondary battery comprises a positive electrode and a negative electrode, which reversibly intercalate and deintercalate a lithium ion, and an electrolyte that contains a lithium ion. The electrolyte may be any of the aforementioned electrolytes. The positive electrode may comprise: a layered compound such as lithium cobalt oxide (LiCoO₂) or lithium nickel oxide (LiNiO₂); such a layered compound in which at least one kind of transition metal has been substituted; lithium manganese oxide (Li_{1+X}Mn_{2-X}O₄, where X=0 to 0.33; Li_{1+X}Mn_{2-X-Y}M_{Y}O₄, where M is at least one selected from the group of metals consisting of Ni, Co, Cr, Cu, Fe, Al, and Mg, X=0 to 0.33, and Y=0 to 1.0, and where 2−X−Y>0; LiMnO₃, LiMn₂O₃, LiMnO₂, LiMn_{2-X}M_{X}O₂, where M is at least one selected from the group of metals consisting of Co, Ni, Fe, Cr, Zn, and Ta, and X=0.01 to 0.1; Li₂Mn₃MO₈, where M is at least one selected from the group of metals consisting of Fe, Co, Ni, Cu, and Zn); a copper-lithium oxide (Li₂CuO₂); an oxide of vanadium such as LiV₃O₈, LiFe₃O₄, V₂O₅, or Cu₂V₂O₇; disulphide compound; or a mixture containing Fe₂(MoO₄)₃, for example.

The negative electrode may comprise: an easily graphitizable material obtained from natural graphite, petroleum coke, or petroleum pitch coke that has been subjected to heat treatment at high temperatures of 2500° C. or higher; mesophase carbon or amorphous carbon; carbon fiber; a metal that alloys with lithium; or a carbon particle carrying a metal on the surface thereof, for example. Examples are metals or alloys selected from the group consisting of lithium, aluminum, tin, silicon, indium, gallium, and magnesium. These metals or their oxides may be utilized in the negative electrode.

The applications of the lithium secondary battery according to the invention are not particularly limited. For example, it may be utilized as the electric power supply for: IC cards; personal computers; large sized computers; notebook computers; stylus-operated computers; notebook word processors; cellular phones; portable cards; wrist watches; cameras; electric shavers; cordless phones; facsimile machines; videos; video cameras; electronic organizers; electronic calculators; electronic organizers with a communications device; portable copy machines; LCD television sets; electric tools; vacuum cleaners; game devices equipped with virtual reality functions; toys; electric bicycles; walking-aid machines for healthcare purposes; wheelchairs for healthcare purposes; moving beds for healthcare purposes; escalators; elevators; forklifts; golf carts; emergency electric supplies; load conditioners; and electric power storage systems. It may also be utilized as the power supply for military or space-exploration purposes, as well as for consumer applications.

### EXAMPLES

In the following, the invention will be described in greater detail by way of examples, which are not to be taken as limiting the scope of the invention. In the following examples, the preparation of samples and the evaluation of ionic conductivity were carried out in an atmosphere of argon, while the evaluation of viscosity was carried out in an atmosphere of nitrogen.

(1) Example of Electrode Preparation

(Positive electrode): Cellseed (lithium cobalt oxide manufactured by Nippon Chemical Industrial Co., Ltd.), SP270 (graphite manufactured by Nippon Graphite Industries, Ltd.), polyethylene carbonate (manufactured by PAC Polymers Inc.; the same applies below), LiN(CF₃SO₂)₂ (manufactured by Aldrich Chemical Co.), and KF1120 (polyvinylidene fluoride manufactured by Kureha Chemical Industry Co., Ltd.; the same applies below) were mixed at a weight % ratio of 70:10:5:10:5. The mixture was then mixed with N-methyl-2-pyrrolidone, thereby preparing a slurry solution. The slurry was applied to an aluminum foil with a thickness of 20 μm by the doctor blade method and was then dried. The amount of the mixture applied was 150 g/m². The aluminum foil was then pressed such that the bulk density of the mixture was 3.0 g/cm³. Thereafter, the aluminum foil was cut into 1 cm×1 cm sections, thereby producing positive electrodes.

(Negative electrode): Carbotron PE (amorphous carbon manufactured by Kureha Chemical Industry Co., Ltd.), polyethylene carbonate, LiN(CF₃SO₂)₂ (manufactured by Aldrich Chemical Co.), and KF1120 (polyvinylidene fluoride manufactured by Kureha Chemical Industry Co., Ltd.) were mixed at a weight % ratio of 80:10:10. The mixture was then mixed with N-methyl-2-pyrrolidone, thereby preparing a slurry solution. The slurry was applied to a copper foil with a thickness of 20 μm by the doctor blade method and was then dried. The amount of the mixture applied was 70 g/m². The copper foil was then pressed such that the bulk density of the mixture was 1.0 g/cm³. Thereafter, the copper foil was cut into 1.2 cm×1.2 cm sections, thereby producing negative electrodes.

(2) Evaluation Method

(Ionic conductivity): In order to measure ionic conductivity, an electrochemical cell was constructed by placing an electrolyte between stainless steel electrodes at 25° C. Resistance components were measured by applying an alternating current across the electrodes in accordance with the alternating-current impedance method. Ionic conductivity was then calculated from a real impedance intercept of a Cole-Cole plot.

(Battery charge/discharge conditions): Using a charger/discharger (TOSCAT3000 manufactured by Toyo System Co., Ltd.), a charge/discharge operation was performed at 25° C. with a current density of 0.5 mA/cm². Constant current charging was conducted up to 4.2 V, whereupon constant voltage charging was conducted for 12 hours. Further, constant current discharge was conducted until the voltage reached a discharge termination voltage of 3.5 V. The capacity that was achieved by the initial discharge was determined to be the initial discharge capacity. A cycle of charging and discharging under the above conditions was repeated until the capacity decreased to 70% or less of the initial discharge capacity, and the number of times the cycle was repeated was designated as a cycle characteristic. Also, constant-current charging was conducted with a current density of 1 mA/cm² up to 4.2 V, whereupon constant-voltage charging was conducted for 12 hours. Further, constant-current discharging was conducted until the voltage reached a discharge termination voltage of 3.5 V. The resultant capacity was compared with the initial cycle capacity obtained in the aforementioned charge/discharge cycle, and their ratio was designated as a high-speed charge/discharge characteristic.

### Example 1

For 1 g of polyethylene carbonate (number-average molecular weight: 50000; manufactured by PAC Polymers Inc.), LiN(C₂F₅SO₂)₂ (manufactured by Aldrich Chemical Co.) was mixed as an electrolyte salt with dimethyl carbonate at a molar ratio of 0.4 with respect to the carbonate group. To this mixture was further added diglyme as an organic solvent at a ratio of 15 parts by weight with respect to 100 parts by weight of polyethylene carbonate, thereby preparing a mixture solution (1). The mixture solution (1) was then applied to a Teflon (trademark; the same applies below). After allowing it to stand in argon at room temperature for 24 hours, it was then allowed to stand in argon at 80° C. for 12 hours and was further subjected to vacuum drying at 80° C. for 12 hours, thus resulting in an electrolyte (thickness: 100 μm).

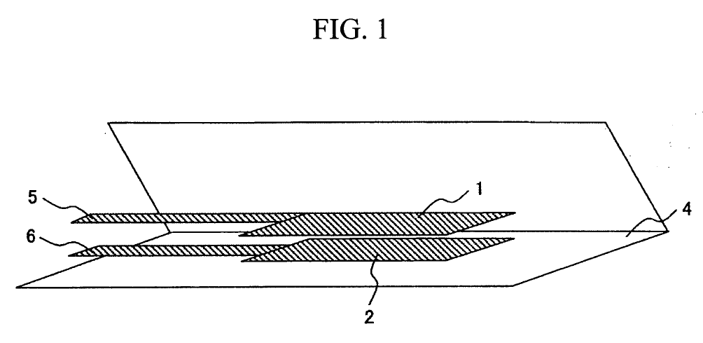

The resultant electrolyte film was cut into a circular plate with a diameter of 1 cm, which was then sandwiched between a pair of stainless steel electrodes to measure its ionic conductivity at 25° C. by the aforementioned ionic conductivity measurement method. The results of measurement of ionic conductivity are shown in Table 1. Further, the mixture solution (1) was cast on each of the positive and negative electrodes prepared by the aforementioned method. After allowing it to stand in argon at 80° C. for 12 hours, the mixture solution was subjected to vacuum drying at 80° C. for 12 hours. The positive and negative electrodes were then laid one upon the other and, under a load of 0.1 MPa, were retained at 80° C. for 6 hours to bind them together. Thereafter, as shown in FIG. 1, stainless steel terminals 5 and 6 were attached to the positive electrode 1 and the negative electrode 2, respectively, and the electrodes were then inserted into a pouched aluminum laminate film 4, thereby preparing a lithium secondary battery. The thus prepared battery was then subjected to measurement of initial discharge capacity, cycle characteristics, and high-speed charge/discharge characteristics, the results of which are shown in Table 1.

### Example 2

Evaluation was conducted in the same manner as in Example 1 except that LiC(CF₃SO₂)₃ was used instead of LiN(C₂F₅SO₂)₂ as the electrolyte salt in Example 1. The results are shown in Table 1.

### Example 3

Evaluation was conducted in the same manner as in Example 1 except that LiN(CF₃SO₂)₂ was used instead of LiN(C₂F₅SO₂)₂ as the electrolyte salt in Example 2. The results are shown in Table 1.

### Example 4

Evaluation was conducted in the same manner as in Example 1 except that gamma-butyrolactone (Tomiyama Pure Chemical Industries, Ltd.) was used instead of diglyme as the organic solvent in Example 1. The results are shown in Table 1.

### Example 5

Evaluation was conducted in the same manner as in Example 4 except that LiC(CF₃SO₂)₃ was used instead of LiN(C₂F₅SO₂)₂ as the electrolyte salt in Example 4. The results are shown in Table 1.

### Example 6

Evaluation was conducted in the same manner as in Example 4 except that LiN(CF₃SO₂)₂ was used instead of LiN(C₂F₅SO₂)₂ as the electrolyte salt in Example 4. The results are shown in Table 1.

### Example 7

Evaluation was conducted in the same manner as in Example 1 except that propylene carbonate (manufactured by Mitsubishi Chemical Corporation) was used instead of diglyme as the organic solvent in Example 1. The results are shown in Table 1.

### Example 8

Evaluation was conducted in the same manner as in Example 4 except that LiC(CF₃SO₂)₂ was used instead of LiN(C₂F₅SO₂)₂ as the electrolyte salt in Example 7. The results are shown in Table 1.

### Example 9

Evaluation was conducted in the same manner as in Example 4 except that LiN(CF₃SO₂)₂ was used instead of LiN(C₂F₅SO₂)₂ as the electrolyte salt in Example 7. The results are shown in Table 1.

### Comparative Example 1

For 1 g of polyethylene carbonate (number-average molecular weight: 50000), LiBF₄ (manufactured by Aldrich Chemical Co.) was mixed as an electrolyte salt with dimethyl carbonate at a molar ratio of 0.4 with respect to the carbonate group. The mixture was then applied to a Teflon. After allowing it to stand in argon at room temperature for 24 hours, it was allowed to stand in argon at 80° C. for 12 hours and was further subjected to vacuum drying at 80° C. for 12 hours, thus resulting in an electrolyte (thickness: 100 μm).

The resultant electrolyte film was cut into a circular plate with a diameter of 1 cm, which was then sandwiched between a pair of stainless steel electrodes to measure its ionic conductivity at 25° C. by the aforementioned ionic conductivity measurement method. The results of measurement of ionic conductivity are shown in Table 1. Further, the mixture solution (1) was cast on each of the positive and negative electrodes prepared by the aforementioned method. After allowing it to stand in argon at 80° C. for 12 hours, the mixture solution was subjected to vacuum drying at 80° C. for 12 hours. The positive and negative electrodes were then laid one upon the other and, under a load of 0.1 MPa, were retained at 80° C. for 6 hours to bind them together. Thereafter, as shown in FIG. 1, stainless steel terminals 5 and 6 were attached to the positive electrode 1 and the negative electrode 2, respectively, and the electrodes were then inserted into a pouched aluminum laminate film 4, thereby preparing a lithium secondary battery.

The thus prepared battery was then subjected to measurement of initial discharge capacity, cycle characteristics, and high-speed charge/discharge characteristics, the result of which is shown in Table 1.

### Comparative Example 2

Evaluation was conducted in the same manner as in Comparative Example 1 except that LiPF₆ was used instead of LiBF₄ as the electrolyte salt in Example 1. The results are shown in Table 1.

### Comparative Example 3

Evaluation was conducted in the same manner as in Comparative Example 1 except that LiN(CF₃SO₂)₂ was used instead of LiBF₄ as the electrolyte salt in Example 2. The results are shown in Table 1.

TABLE 1

| | | | | | | | | Initial | | High-speed |
|---|---|---|---|---|---|---|---|---|---|---|
| | Organic solvent | | | Electrolyte | | | | discharge | | charge/discharge |
| | | Gamma- | Propylene | LiN | LiC | LiN | Ion conductivity | capacity | Cycle life | characteristics |
| Ex. | Diglyme | butyrolactone | carbonate | (C₂F₅SO₂)₂ | (CF₃SO₂)₃ | (CF₃SO₂)₂ | (mS/cm) | (mAh) | (times) | (%) |
| 1 | Yes | — | — | Yes | — | — | 1.1 | 1 | 250 | 75 |
| 2 | Yes | — | — | — | Yes | — | 1.2 | 1 | 280 | 75 |
| 3 | Yes | — | — | — | — | Yes | 1.4 | 1.1 | 300 | 80 |
| 4 | — | Yes | — | Yes | — | — | 1.2 | 1.2 | 300 | 80 |
| 5 | — | Yes | — | — | Yes | — | 1.3 | 1.2 | 330 | 80 |
| 6 | — | Yes | — | — | — | Yes | 1.4 | 1.2 | 390 | 85 |
| 7 | — | — | Yes | Yes | — | — | 1.1 | 1.2 | 420 | 85 |
| 8 | — | — | Yes | — | Yes | — | 1.6 | 1.2 | 450 | 85 |
| 9 | — | — | Yes | — | — | Yes | 2.1 | 1.2 | 500 | 90 |
| Comp. | — | — | Yes | — | — | — | 0.02 | 0.12 | 100 | 25 |
| Ex. 1 | | | | | | | | | | |
| Comp. | — | — | Yes | — | — | — | 0.06 | 0.21 | 120 | 30 |
| Ex. 2 | | | | | | | | | | |
| Comp. | — | — | Yes | — | — | Yes | 0.12 | 0.42 | 150 | 40 |
| Ex. 3 | | | | | | | | | | |

1. An electrolyte comprising:
a polymer having a carbonate group represented by formula (1): 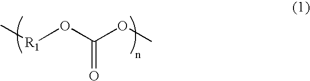
where R₁ is a hydrocarbon group with a carbon number of 2 to 7, and n is an integer from 10 to 10000;
an electrolyte salt; and
an organic solvent.

2. The electrolyte according to claim 1, wherein said electrolyte salt is contained at a molar ratio of 0.2 or more with respect to said carbonate group.

3. The electrolyte according to claim 1 or 2, wherein said electrolyte salt is at least one selected from the group consisting of LiN(CF₃SO₂)₂, LiN(C₂F₅SO₂)₂, and LiC(CF₃SO₂)₃.

4. The electrolyte according to any one of claims 1 to 3, wherein said organic solvent is contained at a ratio of 1 to 50 parts by weight with respect to 100 parts by weight of said polymer having a carbonate group.

5. A lithium secondary battery comprising a positive electrode and a negative electrode that reversibly intercalate and deintercalate lithium, and an electrolyte containing a lithium ion, wherein said electrolyte comprises:
a polymer having a carbonate group represented by formula (1): 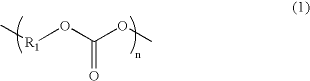
where R₁ is a hydrocarbon group with a carbon number of 2 to 7, and n is an integer from 10 to 10000; an electrolyte salt; and
an organic solvent:

6. The lithium secondary battery according to claim 5, wherein said electrolyte salt is contained at the molar ratio of 0.2 or more with respect to said carbonate group.

7. The lithium secondary battery according to claim 5 or 6, wherein said electrolyte salt is at least one selected from the group consisting of LiN(CF₃SO₂)₂, LiN(C₂F₅SO₂)₂, and LiC(CF₃SO₂)₃.

8. The lithium secondary battery according to any one of claims 5 to 7, wherein said organic solvent is contained at a ratio of 1 to 50 parts by weight with respect to 100 parts by weight of said polymer having a carbonate group.
